(19) United States
(12) Patent Application Publication
(10) Pub. No.: US 2022/0382884 A1
(43) Pub. Date: Dec. 1, 2022

(54) METHOD AND DEVICE FOR PARSING SHARED PASSWORD

(71) Applicant: BEIJING DAJIA INTERNET INFORMATION TECHNOLOGY CO., LTD., Beijing (CN)

(72) Inventors: Yun CHEN, Beijing (CN); Bi QIN, Beijing (CN)

(21) Appl. No.: 17/819,139

(22) Filed: Aug. 11, 2022

Related U.S. Application Data
(63) Continuation of application No. PCT/CN2021/075647, filed on Feb. 5, 2021.

(30) Foreign Application Priority Data
Feb. 28, 2020 (CN) 202010129775.4

(51) Int. Cl. G06F 21/60; H04L 9/32

(52) U.S. Cl. CPC G06F 21/602; H04L 9/3226

(57) ABSTRACT

A shared password analysis method and device. The shared password analysis method comprises: obtaining a shared password, the shared password comprising a target character string; performing detection on the target character string, and in response to a case that the target character string contains a mark character, segmenting the target character string according to the mark character to obtain a verification character string and a data sharing character string; using a preset first key on a client to verify the verification character string; and in response to a case that the verification result indicates that the verification is passed, decrypting the data sharing character string by using a preset second key on the client to obtain shared data.

### CROSS-REFERENCE TO RELATED APPLICATION

The present disclosure is a continuation of PCT Application No. PCT/CN2021/075647, filed Feb. 5, 2021, which claims priority to Chinese Patent Application with the application number 202010129775.4, titled “Method and Apparatus for Parsing Shared Password, Electronic Device and Storage Medium”, and filed Feb. 28, 2020, the entire contents of which are incorporated herein by reference.

### TECHNICAL FIELD

The present application relates to the technical field of data transmission, and in particular, to a method and apparatus for parsing a shared password, an electronic device and a storage medium.

### BACKGROUND

With the rapid progress of modern information transmission technology and the popularization of various smart devices, after using some applications and social software corresponding to the applications, people often find a lot of data content they want to share, and use web pages, or small programs, or other manners to share the page they want to share. When sharing the data in the application, the conventional method for parsing a shared password usually needs to access a server interface, then determine the final content to be shared according to data returned by the interface, and then share the favorite content to the third-party platform.

However, the whole process of accessing the server interface, then determining the final content to be shared according to the data returned by the interface, and then sharing the favorite content to the third-party platform needs to be carried out under the condition of a network, and in the absence of a network or in an unstable network environment, the sharing of data or content cannot be achieved.

### SUMMARY

The present application provides a method and apparatus for parsing a shared password, an electronic device and a storage medium. The technical solutions of the present application are as follows.

According to the first aspect of the embodiments of the present application, there is provided a method for parsing a shared password, applied to a client, including:

acquiring a shared password, where the shared password includes a target string;

detecting the target string, and in response to that the target string includes a flag character, segmenting the target string according to the flag character to obtain a verification string and a data shared string;

verifying the verification string by using a first key preset on the client to obtain a verification result; and

in response to the verification result being verification passed, obtaining shared data by decrypting the data shared string by using a second key preset on the client.

According to a second aspect of the embodiments of the present application, there is provided an apparatus for parsing a shared password, applied to a client, including:

a shared password acquiring unit, configured to acquire a shared password, where the shared password includes a target string;

a target string segmentation unit, configured to detect the target string, and in response to that the target string includes a flag character, segment the target string according to the flag character to obtain a verification string and a data shared string;

a string verification unit, configured to verify the verification string by using a first key preset on the client to obtain a verification result;

a shared password parsing unit, configured to, in response to the verification result being verification passed, obtain shared data by decrypting the data shared string by using a second key preset on the client.

According to a third aspect of the embodiments of the present application, there is provided an electronic device, including:

a processor;

a memory for storing instructions executable by the processor;

where the processor is configured to execute the instructions to implement the method for parsing a shared password described in the above first aspect.

According to a fourth aspect of the embodiments of the present application, there is provided a storage medium, which is executed by a processor of an electronic device in response to an instruction in the storage medium, so that the electronic device can perform the method for parsing a shared password described in the above first aspect.

According to a fifth aspect of the embodiments of the present application, there is provided a computer program product including instructions, in response to the computer program product being executed on a computer, the computer is caused to execute the method for parsing a shared password described in the above first aspect.

### BRIEF DESCRIPTION OF THE DRAWINGS

The accompanying drawings, which are incorporated in and constitute a part of this specification, illustrate embodiments consistent with the present disclosure, together with the description, serve to explain the principles of the present disclosure, and do not constitute an improper limitation of the present disclosure.

FIG. 1 is a flow chart of a method for parsing a shared password according to an exemplary embodiment.

FIG. 2 is a flow chart of a possible implementation manner of step S300 according to an exemplary embodiment.

FIG. 3 is a flowchart of an implementation manner before step S100 according to an exemplary embodiment.

FIG. 4 is a block diagram of an apparatus for parsing a shared password according to an exemplary embodiment.

FIG. 5 is a block diagram of an electronic device for parsing a shared password according to an exemplary embodiment.

FIG. 6 is a block diagram of an apparatus for parsing a shared password according to an exemplary embodiment.

### DETAILED DESCRIPTION

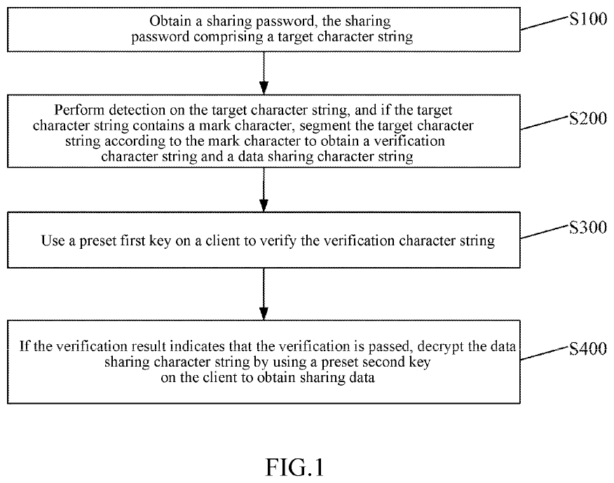

FIG. 1 is a flowchart of a method for parsing a shared password according to an exemplary embodiment. The method can be performed by an electronic device, such as a mobile phone, a computer, a digital broadcast terminal, a messaging device, a game console, a tablet, a medical device, exercise equipment, a personal digital assistant, and the like. As shown in FIG. 1, the method includes the following steps.

In step S100, a shared password is acquired, and the shared password includes a target string.

In step S200, the target string is detected, and in response to the target string containing a flag character, the target string is segmented according to the flag character to obtain a verification string and a data shared string.

In step S300, the verification string is verified by using a first key preset on the client.

In step S400, in response to the verification result being that the verification is passed, the data shared string is decrypted by using a second key preset on the client to obtain shared data.

Among them, the flag character refers to a specific character preset by a specific application or client during generation of the password. According to the specific character, it can be determined whether the target string in the shared password is the password or target string that the corresponding application or client needs to share. The preset first key is a specific key preset in the process of generating the shared password, and using this key to encrypt the same data can obtain encrypted data consistent with the process of generating the shared password. By comparing the encrypted data in the two processes, the legitimacy of the shared password can be further determined. The preset second key is a specific key preset in the process of generating the shared password. This key is used to decrypt and encrypt the data shared string, and the same key is used to decrypt the data shared string, therefore the security of shared data during the data sharing process can be improved.

In some embodiments, after acquiring the shared password and the target string corresponding to the shared password, the target string is detected, and in response to the target string not containing the flag character, it is considered that the shared password is not a password generated by the specific application or client, no subsequent operations will be performed, and the shared password will be ignored. In response to that the flag character is contained in the target string, it is considered that the shared password is a password generated by the specific application or client, and the specific application or client is applied to segment the target string according to the flag character to obtain the verification string and the data shared string. The verification string is verified by using the first key preset on the client. In response to the verification failure, it is considered that the shared password has an error in the transmission process and is not the password generated by the original application or client, but is an illegal password (illegal tampering or wrong delivery may result in an illegal shared password), then no follow-up operations will be performed and the shared password will be ignored. In response to the verification being passed, it is considered that the shared password is a password generated by the original application or client, and is a valid password. After determining that the shared password is a valid password, the data shared string is decrypted by using the second key preset on the client to obtain the shared data.

In the above method for parsing a shared password, the shared password is acquired, the shared password including the target string; the target string is detected, and in response to the target string containing the flag character, the target string is segmented according to the flag character, and the verification string and the data shared string are obtained; the verification string is verified by using the first key preset on the client; in response to the verification result being that the verification is passed, the data shared string is decrypted by using the second password preset on the client to obtain the shared data. When a specific application or client is started, the preset first key and second key are placed in the application or client, and then the specific application or client is used to detect the target string, in response to the target string containing the flag character, it means that the target string is a string corresponding to the specific application or client, and further, the first key preset on the application or client is applied to verify the verification string. In response to the verification result being that the verification is passed, it means that the target string is a string corresponding to a legal password corresponding to the application or client, and the second key preset on the application or client is used to decrypt the data shared string to obtain the shared data. By decrypting the data shared string by using the second key preset on the application or the client to obtain the shared data, the safety of the shared data is further ensured. The preset first key and second key have been placed in the specific application or client when the application or client is started. Therefore, the entire process of parsing the shared password and obtaining the shared data is implemented based on the application or client, it does not involve whether the server is accessed or not, nor does it involve the existence of the network or whether the network environment is stable. It can realize the sharing of data or content in the absence of a network or an unstable network environment.

In an exemplary embodiment, it is a possible implementation of step S200 shown in an exemplary embodiment, where segmenting the target string according to the flag character to obtain a verification string and a data shared string, includes:

determining characters on a first side of the flag character in the target string as the verification string; determining characters on a second side of the flag character in the target string as the data shared string.

In some embodiments, according to a string generation method of a specific application or client when generating the shared password, the characters on the first side of the flag character in the target string are determined as the verification string, and the characters on the second side of the flag character in the target string are determined as the data shared string.

In the above exemplary embodiment, segmenting the target string to obtain the verification string and the data shared string is a segmentation corresponding to the method of generating the string when generating the shared password, which provides a basis for the subsequent identification of whether the shared password is a shared password corresponding to a specific application program or client, and also provides a basis for the identification of the legality of the shared password.

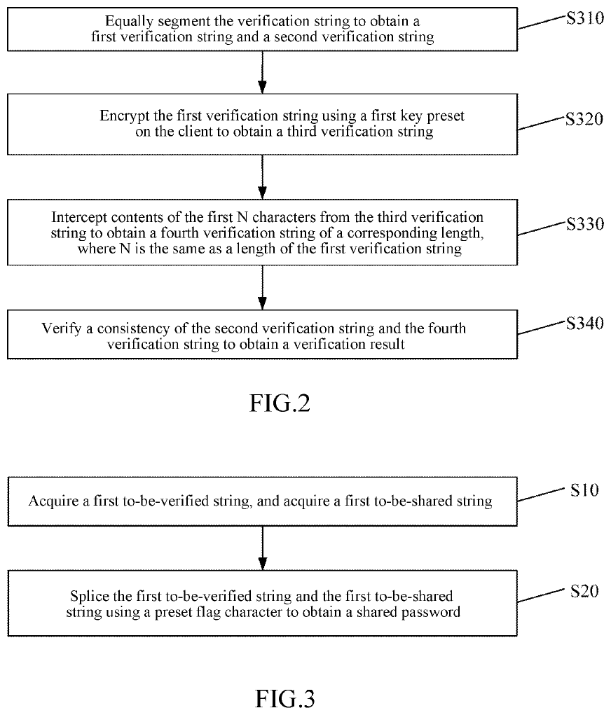

In an exemplary embodiment, as shown in FIG. 2, it is a flowchart of an implementable manner of step S300 shown in an exemplary embodiment, where the verification of the verification string includes the following steps.

In step S310, the verification string is equally segmented to obtain a first verification string and a second verification string.

In step S320, the first verification string is encrypted by using the first key preset on the client to obtain a third verification string.

In step S330, contents of the first N characters are cut out from the third verification string to obtain a fourth verification string of a corresponding length, where N is the same as the length of the first verification string.

In step S340, the consistency of the second verification string and the fourth verification string is verified to obtain a verification result.

In some embodiments, according to the method used when the application or the client generates the shared password, the verification string is relatively divided to obtain the first verification string and the second verification string. In some embodiments, the verification string is evenly divided to obtain the first verification string and the second verification string. For example, when the shared password is generated, the first verification string is encrypted and the fourth verification string corresponding to the length of the first verification string is intercepted. Then in the process of verification, the first verification string is encrypted by using the first key preset on the client, and the fourth verification string of length N corresponding to the length of the first verification string is intercepted from the obtained third verification string, and then the consistency of the second verification string and the fourth verification string with equal lengths is verified to obtain a verification result. In some embodiments, the first verification string is symmetrically encrypted by using the first key preset on the client.

In the above exemplary embodiment, the verification string is divided evenly to obtain the first verification string and the second verification string; the first verification string is encrypted by using the first key preset on the client to obtain a third verification string; contents of the first N characters are intercepted from the third verification string to obtain a fourth verification string of a corresponding length, where N is the same as the length of the first verification string; the consistency of the second verification string and the fourth verification string is verified to obtain a verification result. Among them, the verification string is verified to obtain a verification result, which can determine whether the corresponding shared password is a legal password corresponding to a specific application or client, and provides a judgment basis for the subsequent decryption of the data shared string by using the preset second key, and further ensures the security of the finally obtained shared data.

In an exemplary embodiment, it is a possible implementation manner of step S340 shown in an exemplary embodiment, where verifying the consistency of the second verification string and the fourth verification string to obtain a verification result, includes the following steps.

The consistency of the second verification string and the fourth verification string is detected; in response to characters in the second verification string being consistent with characters in the fourth verification string, the verification is passed; in response to the characters in the second check character being inconsistent with the characters in the fourth verification string, the verification fails; and the pass of verification and the failure of verification are determined as the verification result.

In some embodiments, it is detected whether the second verification string is consistent with the fourth verification string, and in response to the fact that the characters in the second verification string are consistent with the characters in the fourth verification string, the verification is passed, and it is considered that the shared password is the password generated by the original application or client, and is a valid password. In response to the characters in the second verification string being inconsistent with the characters the fourth verification string, the verification fails, the verification string is verified, and in response to that the verification is passed, the shared password is considered to be the password generated by the original application or the client, and is a valid password.

In the above exemplary embodiment, the first key preset on the client is used to verify the consistency of the second verification string and the fourth verification string, and a verification result is obtained, which provides a judgment basis for the subsequent decryption of the data shared string by using the preset second key, and further ensures the security of the finally obtained shared data.

In an exemplary embodiment, it is a possible implementation manner after step S300 shown in an exemplary embodiment, where in response to the verification result being that the verification is passed, after decrypting the data shared string by using the second password preset on the client to obtain the shared data, the method includes:

parsing the shared data to obtain a shared content corresponding to the shared data.

In some embodiments, the shared data is data including identification information of the shared content, which itself is a kind of data and corresponds to a specific shared content. Therefore, after the shared data is obtained, the shared data needs to be parsed, and then the shared content corresponding to the shared data can be obtained.

In an exemplary embodiment, as shown in FIG. 3, it is a flowchart of an implementation manner before step S100 shown in an exemplary embodiment, where the generation method of the shared password includes the following steps.

In step S10, a first to-be-verified string is acquired, and a first to-be-shared string is acquired.

In step S20, the first to-be-verified string and the first to-be-shared string are concatenated by using a preset flag character to obtain a shared password.

The first to-be-verified string refers to a string of a corresponding check bit during data sharing, and it can be subsequently determined whether one shared password is a password corresponding to a specific application or client according to the first to-be-verified string. The first to-be-shared string is identification information corresponding to data needing to be shared. The flag character refers to a specific character preset in the password generation of a specific application or client. The specific character may be used to subsequently determine whether the target string in the shared password is the password or target string that the corresponding application or client needs to share.

In some embodiments, the first to-be-verified string and the first to-be-shared string are spliced by using a preset flag character to obtain the shared password.

In some embodiments, one string is randomly generated as a second to-be-verified string, and a length of the second to-be-verified string is a random length within a preset range; the second to-be-verified string is encrypted by using the first key preset on the client to obtain a third to-be-verified string; the content of the first M characters is intercepted from the third to-be-verified string to obtain a fourth to-be-verified string, M is the same as the length of the second to-be-verified string; the second to-be-verified string and the fourth to-be-verified string are concatenated to obtain the first to-be-verified string. In some embodiments, the second to-be-verified string is symmetrically encrypted by using the first key preset on the client to obtain the third to-be-verified string.

In some embodiments, the to-be-shared data is obtained, and the to-be-shared data is data including identification information of the shared content; the to-be-shared data is encoded to obtain a second to-be-shared string; the second to-be-shared string is encrypted by using the second key preset on the client to obtain the first to-be-shared string. In some embodiments, the second to-be-shared string is symmetrically encrypted by using the second key to obtain the first to-be-shared string.

In some embodiments, the above-mentioned preset first key is a key for encrypting the second to-be-verified string during the generation process of the shared password, and the encryption process can obtain a third to-be-verified string. In the process of parsing the shared data during the data sharing process, the key can be used to encrypt the same data, and the encrypted data which is consistent with that in the shared password generation process can be obtained. By comparing the encrypted data in the two processes, the legitimacy of the shared password can be further determined. In some embodiments, in a specific embodiment, the above-mentioned intercepted length M is consistent with the intercepted length N.

The preset second key is an encryption key for the data that needs to be shared in the process of generating the shared password, which provides a basis for the subsequent decryption of the data shared string by using the preset second key on the client, and further guarantees security of the resulting shared data.

In the process of encoding the to-be-shared data to obtain the second to-be-shared string, it can be encoded as a JSON string, and at the same time, in order for simplification of information and generality, the service information may be encoded into one URI.

In the above exemplary embodiment, in the process of generating the shared password, by encrypting the second to-be-verified string by using the first key preset on the client, the legitimacy of the shared password can be determined in the process of data sharing parsing, and the security of the data sharing process can be improved. By encrypting the data that needs to be shared by using the second key preset on the client during the generation process of the shared password, the security of the to-be-shared data can be ensured.

In an exemplary embodiment, the method provided by the present application may include a shared password generating step and a shared password parsing step, where the shared password is:

ihlx7EQjB+=U2FsdGVkX1/GQRLmjupTxg+FL5FKbrM93/KODvATq026Q/GOreKZSNb12HgfW+XMmb6LFQydXNtd51dSKcNWpTNEWDdTxHHJHZJpECIPix1KjB Et0nW1GWeQzseBYttv.

The shared password generating step and the shared password parsing step may be as follows.

The shared password generating step includes: randomly generating one string A, such as “ihlx7” in the above example, where a length of the string is required to be random between 3-6 (exemplary description, no specific limitation) characters. The range of the characters of the string (the range of acquisition is only an example, not specifically limited) may be as follows:

0123456789ABCDEFGHIJKLMNOPQRSTUVWXYZabcdefghijklmnopqrstuvwxyz.

The obtained string A is symmetrically encrypted with a key X to obtain the encrypted string B. The first few characters of the encrypted string B are intercepted, the length is the same as the length of the string A, and the intercepted string C is for example “EQjB+” in the example. The string A and the string C are concatenated together to obtain a string D, such as “ihlx7EQjB+” in the example, and the string D may be used as a verification password. The data required for sharing is encoded into one JSON string E. Considering the different information required by different services, the service information may be encoded into one URI in order for simplification of the information and generality. In this way, the standard URI library may be used for parsing during usage. For example, the shared data corresponding to the user's home page is scheme://user/{userId}, and the content example of the JSON string is {“uri”: “scheme://user/123”}. The JSON string E is symmetrically encrypted with a key Y to obtain the encrypted string F. The string D and the string F are concatenated with a special character to obtain the shared password G of the application or client to be shared at last. In some embodiments, the special character may be “=”.

The shared password parsing step includes: searching for an agreed special character (such as “=”) from the shared password string G, if not found, it means that this string is not the password corresponding to the application or client used for searching. In the case that the agreed special character is found, it means that this string is the password corresponding to the application or client used for searching, and then all the strings of the two parts before and after the special character are extracted. For the convenience of description, the string before the special character is named H, and the string after the special character is named I. The string H is divided into two substrings equally according to the length, i.e., the first half of the string J and the second half of the string K. The string J is symmetrically encrypted with a key X in the same way as when generating the shared password to obtain the string M. In the case that the first few characters of the same length of the string M and the string K are different, the password is invalid, and the password string will not continue to be processed. If the first few characters of the same length of the string M and the string K are the same, the password is valid. In response to the valid password, the string I is decrypted with a key Y to obtain the shared data. Finally, the shared content is displayed to the user according to the shared data.

In the above exemplary embodiment, the generation and parsing of the shared password do not require the participation of the server, and are completed locally on the client. Since there is no need to access the server, the content can be shared even when the user network is poor or even without a network, which increases the success rate of sharing. Especially when there is an activity that causes a sudden increase in the shared volume and the server cannot handle it, it can be downgraded to the client password to ensure the normal operation of the activity. At the same time, different service information is processed into standard format strings by URI, which is convenient for standardized processing and production. The verification string in the shared password can ensure that the password will not be forged. And by encrypting the shared data, it ensures that the shared sensitive information will not be leaked.

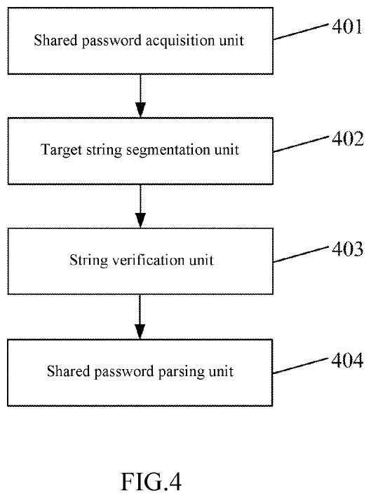

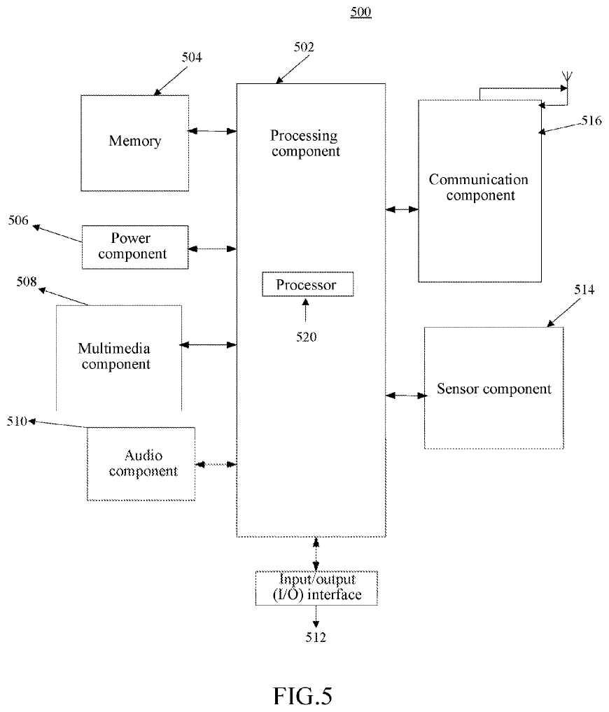

FIG. 4 is a block diagram of an apparatus for parsing a shared password according to an exemplary embodiment. With reference to FIG. 4, the apparatus includes a shared password acquisition unit 401, a target string segmentation unit 402, a string verification unit 403 and a shared password parsing unit 404.

The shared password acquisition unit 401 is configured to acquire a shared password, and the shared password includes a target string.

The target string segmentation unit 402 is configured to: detect the target string, and in response to the target string containing a flag character, segment the target string according to the flag character to obtain a verification string and a data shared string.

The string verification unit 403 is configured to verify the verification string by using a first key preset on the client.

The shared password parsing unit is configured to, in a case that the verification result is that the verification is passed, decrypt the data shared string by using a second key preset on the client to obtain shared data.

In an exemplary embodiment, the target string segmentation unit 402 is further configured to: determine characters on a first side of the flag character in the target string as a verification string; and determine characters on a second side of the flag character in the target string as a data shared string.

In an exemplary embodiment, the string verification unit 402 is further configured to: segment the verification string equally to obtain a first verification string and a second verification string; encrypt the first verification string by using a first key preset on the client to obtain a third verification string; intercept the first N characters from the third verification string to obtain a fourth verification string, where N is the same as a length of the first verification string; verify a consistency of the second verification string and the fourth verification string to obtain a verification result.

In an exemplary embodiment, the string verification unit 403 is further configured to: detect the consistency of the second verification string and the fourth verification string; in response to that characters in the second verification string and the fourth verification string are consistent, the verification is passed; in response to that the characters in the second verification string and the fourth verification string are inconsistent, the verification fails; and determine the pass of the verification and the failure of the verification as the verification result.

In an exemplary embodiment, the apparatus for parsing a shared password further includes a content shared unit, configured to: parse the shared data to obtain a shared content corresponding to the shared data.

In an exemplary embodiment, the apparatus for parsing a shared password further includes a shared password generating unit, configured to: obtain a first to-be-verified string, and obtain a first to-be-shared string; concatenate the first to-be-verified string with the first to-be-shared string to obtain a shared password.

In an exemplary embodiment, the shared password generating unit is further configured to: randomly generate one string as a second to-be-verified string, where a length of the second to-be-verified string is a random length within a preset range; encrypt the second to-be-verified string with a first key preset on the client to obtain a third to-be-verified string; intercept content of the first M characters from the third to-be-verified string to obtain a fourth to-be-verified string, where M is the same as a length of the second to-be-verified string; concatenate the second to-be-verified string and the fourth to-be-verified string to obtain the first to-be-verified string.

In an exemplary embodiment, the shared password generating unit is further configured to: acquire to-be-shared data, the to-be-shared data being data including identification information of a shared content; encode the to-be-shared data to obtain a second to-be-shared string; encrypt the second to-be-shared string by using the second key preset on the client to obtain the first to-be-shared string.

Regarding the apparatuses in the above-mentioned embodiments, the implementation of the operation performed by each module therein has been described in detail in the embodiments related to the method, and detailed description will not be given here.

FIG. 5 is a block diagram of an electronic device 500 for parsing a shared password according to an exemplary embodiment. For example, the device 500 may be a mobile phone, a computer, a digital broadcast terminal, a messaging device, a game console, a tablet, a medical device, exercise equipment, a personal digital assistant, and the like.

Referring to FIG. 5, the device 500 may include one or more of the following components: a processing component 502, a memory 504, a power component 506, a multimedia component 508, an audio component 510, an input/output (I/O) interface 512, a sensor component 514, and a communication component 516.

The processing component 502 typically controls overall operations of the device 500, such as the operations associated with display, telephone calls, data communications, camera operations, and recording operations. The processing component 502 may include one or more processors 520 to execute instructions to complete all or part of the steps in the above-mentioned method for parsing a shared password. In some embodiments, the processor 520 is configured to execute the instructions to implement the following steps: acquiring a shared password, where the shared password includes a target string; detecting the target string, and in response to that the target string contains a flag character, segmenting the target string according to the flag character to obtain a verification string and a data shared string; verifying the verification string by using a first key preset on the client; in response to the verification result being that the verification is passed, decrypting the data shared string by using a second key preset on the client to obtain shared data.

In some embodiments, the processor 520 is configured to execute the instructions to implement the following steps: determining characters on a first side of the flag character in the target string as a verification string; determining characters on a second side of the flag character in the target string as a data shared string.

In some embodiments, the processor 520 is configured to execute the instructions to implement the following steps: evenly dividing the verification string to obtain a first verification string and a second verification string; encrypting the first verification string by using a first key preset on the client to obtain a third verification string; intercepting the first N characters from the third verification string to obtain a fourth verification string, where N is the same as a length of the first verification string; verifying a consistency of the second verification string and the fourth verification string to obtain a verification result.

In some embodiments, the processor 520 is configured to execute the instructions to implement the following steps: detecting the consistency of the second verification string and the fourth verification string; in response to that the characters in the second verification string and the fourth verification string are consistent, determining that the verification is passed; in response to that the characters in the second verification string and the fourth verification string are inconsistent, determining that the verification fails; determining the pass of the verification and the failure of the verification as the verification result.

In some embodiments, the processor 520 is configured to execute the instructions to implement the following steps: parsing the shared data to obtain a shared content corresponding to the shared data.

In some embodiments, the processor 520 is configured to execute the instructions to implement the following steps: acquiring a first to-be-verified string, and acquiring a first to-be-shared string; splicing the first to-be-verified string with the first to-be-shared string by using a preset flag character to obtain the shared password.

In some embodiments, the processor 520 is configured to execute the instructions to implement the following steps: randomly generating one string as a second to-be-verified string, where a length of the second to-be-verified string is a random length within a preset range; encrypting the second to-be-verified string by using the first key preset on the client to obtain a third to-be-verified string; intercepting a content of the first M characters from the third to-be-verified string to obtain a fourth to-be-verified string, where M is the same as a length of the second to-be-verified string; splicing the second to-be-verified string and the fourth to-be-verified string to obtain the first to-be-verified string.

In some embodiments, the processor 520 is configured to execute the instructions to implement the following steps: acquiring to-be-shared data, where the to-be-shared data is data including identification information of the shared content; encoding the to-be-shared data to obtain a second to-be-shared string; encrypting the second to-be-shared string by using a second key preset on the client to obtain the first to-be-shared string.

Moreover, the processing component 502 may include one or more modules which facilitate the interaction between the processing component 502 and other components. For instance, the processing component 502 may include a multimedia module to facilitate the interaction between the multimedia component 508 and the processing component 502.

The memory 504 is configured to store various types of data to support the operation of the device 500. Examples of such data include instructions for any applications or methods operated on the device 500, contact data, phonebook data, messages, pictures, videos, etc. The memory 504 may be implemented by using any type of volatile or non-volatile storage devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 506 provides power to various components of the device 500. The power component 506 may include a power management system, one or more power supplies, and any other components associated with the generation, management, and distribution of power in the device 500.

The multimedia component 508 includes a screen providing an output interface between the device 500 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 508 includes a front camera and/or a rear camera. The front camera and/or the rear camera may receive an external multimedia datum while the device 500 is in an operation mode, such as a photographing mode or a video mode. Each of the front camera and the rear camera may be a fixed optical lens system or have focus and optical zoom capability.

The audio component 510 is configured to output and/or input audio signals. For example, the audio component 510 includes a microphone (MIC) configured to receive an external audio signal when the device 500 is in an operation mode, such as a call mode, a recording mode, and a voice recognition mode. The received audio signal may be further stored in the memory 504 or transmitted via the communication component 516. In some embodiments, the audio component 510 further includes a speaker to output audio signals.

The I/O interface 512 provides an interface between the processing component 502 and peripheral interface modules, such as a keyboard, a click wheel, buttons, and the like. The buttons may include, but are not limited to, a home button, a volume button, a starting button, and a locking button.

The sensor component 514 includes one or more sensors to provide status assessments of various aspects of the device 500. For instance, the sensor component 514 may detect an open/closed state of the device 500, relative positioning of components, e.g., the display and the keypad, of the device 500, a change in position of the device 500 or a component of the device 500, a presence or absence of user contact with the device 500, an orientation or an acceleration/deceleration of the device 500, and a change in temperature of the device 500. The sensor component 514 may include a proximity sensor configured to detect the presence of nearby objects without any physical contact. The sensor component 514 may also include a light sensor, such as a CMOS or CCD image sensor, for use in imaging applications. In some embodiments, the sensor assembly 514 may also include an acceleration sensor, a gyroscope sensor, a magnetic sensor, a pressure sensor, or a temperature sensor.

The Communication component 516 is configured to facilitate communication, wired or wirelessly, between the device 500 and other devices. The device 500 can access a wireless network based on a communication standard, such as WiFi, Operater network (such as 2G, 3G, 4G, or 5G), or a combination thereof. In one exemplary embodiment, the communication component 516 receives a broadcast signal or broadcast associated information from an external broadcast management system via a broadcast channel. In one exemplary embodiment, the communication component 516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology and other technologies.

In exemplary embodiments, the device 500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above-mentioned method for parsing a shared password.

In an exemplary embodiment, there is also provided a storage medium including instructions, such as a memory 504 including instructions, and the instructions can be executed by the processor 520 of the device 500 to complete the above-mentioned method for parsing a shared password. In some embodiments, the storage medium may be a non-transitory computer-readable storage medium, for example, the non-transitory computer-readable storage medium may be an ROM, a random access memory (RAM), a CD-ROM, a magnetic tape, a floppy disk, and an optical data storage device, etc.

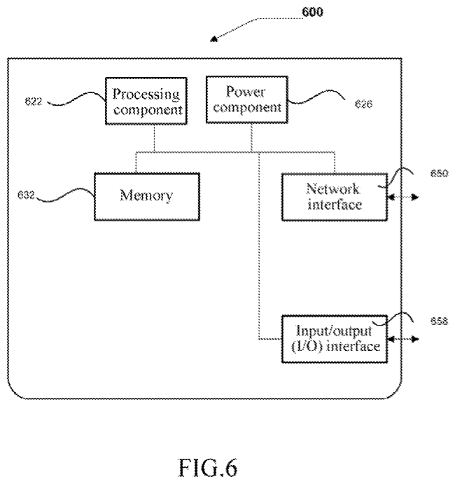

FIG. 6 is a block diagram of an apparatus 600 for parsing a shared password according to an exemplary embodiment. For example, the apparatus 600 may be provided as a server. With reference to FIG. 6, the apparatus 600 includes a processing component 622, which further includes one or more processors, and a memory resource, represented by a memory 632, for storing instructions executable by the processing component 622, such as applications. The application program stored in the memory 632 may include one or more modules, each corresponding to a set of instructions. Additionally, the processing component 622 is configured to execute the instructions to perform the above-described method for parsing a shared password.

The apparatus 600 may also include a power component 626 configured to perform power management of the apparatus 600, a wired or wireless network interface 650 configured to connect the apparatus 600 to the network, and an input/output (I/O) interface 658. The apparatus 600 may operate an operating system stored in the memory 632.

What is claimed is:

1. A method for parsing a shared password, applied to a client, comprising:
acquiring a shared password, wherein the shared password comprises a target string;
detecting the target string, and in response to that the target string comprises a flag character, segmenting the target string according to the flag character to obtain a verification string and a data shared string;
verifying the verification string by using a first key preset on the client to obtain a verification result; and
in response to the verification result being verification passed, obtaining shared data by decrypting the data shared string by using a second key preset on the client.

2. The method according to claim 1, wherein said segmenting the target string according to the flag character to obtain the verification string and the data shared string, comprises:
determining characters on a first side of the flag character in the target string as the verification string;
determining characters on a second side of the flag character in the target string as the data shared string.

3. The method according to claim 1, wherein said verifying the verification string by using the first key preset on the client, comprises:
segmenting the verification string equally to obtain a first verification string and a second verification string;
encrypting the first verification string by using the first key preset on the client to obtain a third verification string;
intercepting content of first N characters from the third verification string to obtain a fourth verification string, wherein N is same as a length of the first verification string;
verifying a consistency of the second verification string and the fourth verification string to obtain the verification result.

4. The method according to claim 3, wherein said verifying the consistency of the second verification string and the fourth verification string to obtain the verification result, comprises:
detecting a consistency of the second verification string and the fourth verification string;
in response to that characters in the second verification string are consistent with characters in the fourth verification string, determining the verification result is that the verification passed;
in response to that the characters in the second verification string are inconsistent with the characters in the fourth verification string, determining the verification result is that the verification failed.

5. The method according to claim 1, further comprising:
parsing the shared data to obtain shared content corresponding to the shared data.

6. The method according to claim 1, wherein a generating manner of the shared password comprises:
acquiring a first to-be-verified string, and acquiring a first to-be-shared string;
splicing the first to-be-verified string and the first to-be-shared string by using a preset flag character to obtain the shared password.

7. The method according to claim 6, wherein said acquiring the first to-be-verified string, comprises:
randomly generating one string as a second to-be-verified string, wherein a length of the second to-be-verified string is a random length within a preset range;
encrypting the second to-be-verified string by using the first key preset on the client to obtain a third to-be-verified string;
intercepting content of first M characters from the third to-be-verified string to obtain a fourth to-be-verified string, wherein M is same as a length of the second to-be-verified string;
splicing the second to-be-verified string and the fourth to-be-verified string to obtain the first to-be-verified string.

8. The method according to claim 6, wherein said acquiring the first to-be-shared string, comprises:
acquiring to-be-shared data, wherein the to-be-shared data is data comprising identification information of shared content;
encoding the to-be-shared data to obtain a second to-be-shared string;
encrypting the second to-be-shared string by using the second key preset on the client to obtain the first to-be-shared string.

9. An electronic device, comprising:
a processor;
a memory for storing instructions executable by the processor;
wherein the processor is configured to execute the instructions to implement following steps:
acquiring a shared password, wherein the shared password comprises a target string;
detecting the target string, and in response to that the target string comprises a flag character, segmenting the target string according to the flag character to obtain a verification string and a data shared string;
verifying the verification string by using a first key preset on the client to obtain a verification result; and
in response to the verification result being verification passed, obtaining shared data by decrypting the data shared string by using a second key preset on the client.

10. The electronic device according to claim 9, wherein the processor is configured to execute the instructions to implement following steps:
determining characters on a first side of the flag character in the target string as the verification string;
determining characters on a second side of the flag character in the target string as the data shared string.

11. The electronic device according to claim 9, wherein the processor is configured to execute the instructions to implement following steps:
segmenting the verification string equally to obtain a first verification string and a second verification string;
encrypting the first verification string by using the first key preset on the client to obtain a third verification string;
intercepting content of first N characters from the third verification string to obtain a fourth verification string, wherein N is same as a length of the first verification string;
verifying a consistency of the second verification string and the fourth verification string to obtain the verification result.

12. The electronic device according to claim 11, wherein the processor is configured to execute the instructions to implement following steps:
detecting a consistency of the second verification string and the fourth verification string;
in response to that characters in the second verification string are consistent with characters in the fourth verification string, determining that the verification result is the verification passed;
in response to that the characters in the second verification string are inconsistent with the characters in the fourth verification string, determining the verification result is that the verification failed.

13. The electronic device according to claim 9, wherein the processor is configured to execute the instructions to implement following steps:
parsing the shared data to obtain shared content corresponding to the shared data.

14. The electronic device according to claim 9, wherein the processor is configured to execute the instructions to implement following steps:
acquiring a first to-be-verified string, and acquiring a first to-be-shared string;
splicing the first to-be-verified string and the first to-be-shared string by using a preset flag character to obtain the shared password.

15. The electronic device according to claim 14, wherein the processor is configured to execute the instructions to implement following steps:
randomly generating one string as a second to-be-verified string, wherein a length of the second to-be-verified string is a random length within a preset range;
encrypting the second to-be-verified string by using the first key preset on the client to obtain a third to-be-verified string;
intercepting content of first M characters from the third to-be-verified string to obtain a fourth to-be-verified string, wherein M is same as a length of the second to-be-verified string;
splicing the second to-be-verified string and the fourth to-be-verified string to obtain the first to-be-verified string.

16. The electronic device according to claim 14, wherein the processor is configured to execute the instructions to implement following steps:
acquiring to-be-shared data, wherein the to-be-shared data is data comprising identification information of shared content;
encoding the to-be-shared data to obtain a second to-be-shared string;
encrypting the second to-be-shared string by using the second key preset on the client to obtain the first to-be-shared string.

17. A non-transitory storage medium carrying instructions thereon to be executed by a processor, wherein execution of the instructions causes the processor to:
acquire a shared password, wherein the shared password comprises a target string;
detect the target string, and in response to that the target string comprises a flag character, segmenting the target string according to the flag character to obtain a verification string and a data shared string;
verify the verification string by using a first key preset on the client to obtain a verification result; and
in response to the verification result being verification passed, obtain shared data by decrypting the data shared string by using a second key preset on the client.

18. The non-transitory storage medium according to claim 17, wherein the execution of the instructions further causes the processor to:
determine characters on a first side of the flag character in the target string as the verification string;
determine characters on a second side of the flag character in the target string as the data shared string.

19. The non-transitory storage medium according to claim 17, wherein the execution of the instructions further causes the processor to:
segment the verification string equally to obtain a first verification string and a second verification string;
encrypt the first verification string by using the first key preset on the client to obtain a third verification string;
intercept content of first N characters from the third verification string to obtain a fourth verification string, wherein N is same as a length of the first verification string;
verify a consistency of the second verification string and the fourth verification string to obtain the verification result.

20. The non-transitory storage medium according to claim 19, wherein the execution of the instructions further causes the processor to:
detect a consistency of the second verification string and the fourth verification string;
in response to that characters in the second verification string are consistent with characters in the fourth verification string, determine the verification result is that the verification passed;
in response to that the characters in the second verification string are inconsistent with the characters in the fourth verification string, determine the verification result is that the verification failed.
